(19) United States
(12) Patent Application Publication
(10) Pub. No.: US 2009/0280460 A1
(43) Pub. Date: Nov. 12, 2009

(54) Systems and methods for providing personalized interactive educational displays

(76) Inventor: David Yaskin, Arlington, VA (US)

Correspondence Address: MCDERMOTT, WILL & EMERY, 11682 EL CAMINO REAL, SUITE 400, SAN DIEGO, CA, 92130-2047, US

(21) Appl. No.: 12/151,579

(22) Filed: May 6, 2008

(51) Int. Cl. G09B 5/00; G09B 7/00

(52) U.S. Cl. 434/307 R; 434/362

(57) ABSTRACT

Systems and methods are provided for capturing student interaction data, wherein the student interaction data has one or more data elements. A student's personalized interactive educational display is configured based at least in part on the captured student interaction data, and then displayed. The systems and methods provide access to resources of an educational institution from the student's configured personalized interactive educational display based at least in part on the captured student interaction data. Directed surveys may be electronically provided to the student based at least in part on the captured student interaction data. The personalized interactive educational display provides controlled access of educational services or commerce services. The personalized interactive educational display electronically provide access to lecture notes, on-line discussion groups, educational resource materials, or course materials. Additional resource materials may also at least in part on the captured student interaction data or academic performance of the student.

### FIELD

The present disclosure generally relates to computer software and hardware systems, and, in particular, relates to systems and methods for providing personalized interactive educational displays to students.

### BACKGROUND

Presently, educational institutions have on-line displays or web pages that provide information based on the selections of a user. Typically, these are publicly-accessible, non-customized displays for a group of users. Such displays may be provided for students presently enrolled in an educational institution, faculty of the institution, prospective students, alumni, or parents and friends of an enrolled student. However, such displays are limited to providing general information to a group of people, and not to a specific individual. Thus, the detail that a user desires can be absent for such general, group-oriented displays. Additionally, since such group-oriented displays are publicly accessible, they typically do not provide full access to particular resources of an educational institution.

Accordingly, there exists a need for systems and methods to provide customized information displays to a user, as well as provide access to information of an educational institution, and to further harmonize the physical world with the online experience of a user.

### SUMMARY

Systems and methods of the disclosure relate to providing a personalized interactive display based, at least in part, on participation in physical events (e.g., attend a class, attend a conference, etc.). An identification card, electronic device, and/or universal account associated with a student may be used to track attendance at one or more events. The information gathered by the registration of the identification of the card at the particular physical event may automatically be used by the system to configure the respective student's interactive display to provide the individual with supplemental materials or additional access (compared to that which would be available to the student had they not physically attended the event). Additionally, the student's attendance of an event, and selections made by the student at the physical event, may automatically trigger the system to provide directed surveys related to products or services provided at the physical event. For example, the identification card may be used to access a dining facility, where the student makes a particular meal selection. A survey may be directed to the student to solicit feedback on his or her dining experience, and/or satisfaction of the meal selection. Additionally, the personalized on-line environment may provide the adaptive release (i.e., control access) of educational and commerce services. For example, attendance at a lecture outside of class where a student identification card is registered may trigger the system to enable particular functionality and access associated with the student's interactive display to provide lecture notes, access to on-line discussion groups, or other resource materials.

Systems and methods are provided for electronically providing a personalized interactive educational display to a student. The systems and methods comprise capturing student interaction data, wherein the student interaction data has one or more data elements. The student's personalized interactive educational display is configured based at least in part on the captured student interaction data. The systems and methods further comprise displaying the student's configured personalized interactive educational display, and providing access to resources of an educational institution from the student's configured personalized interactive educational display based at least in part on the captured student interaction data.

The systems and methods may capture the student interaction data from the swiping a card configured with student data, reading a card configured with student data with a proximity reader, retrieving student data stored on an electronic device via a wired or wireless communication interchange, recording a computer login event using student identifier data, or digitally capturing student identification information from an electronically submitted communication, or any combination thereof.

The capturing of the student interaction data indicates student class attendance, student activity attendance, student educational event attendance, student cultural event attendance, student athletic event attendance, student participation in one or more on-line communities, student entertainment attendance, student patronage of on-campus merchants, student patronage of off-campus merchants, student patronage of on-line merchants, student utilization of an on-campus resource, student utilization of an off-campus resource, student electronic submission of an assignment, student electronic submission of student identification information, athletic facilities utilization, laboratory facilities utilization, dining facilities utilization, research facilities utilization, recreational facilities utilization, classroom facilities utilization, computing facilities utilization, performance space facilities utilization, clinical facilities utilization, art studio facilities utilization, dormitory facilities utilization, parking facilities utilization, retail facilities utilization, entertainment facilities utilization, or library facilities utilization or any combination thereof.

The systems and methods may provide directed surveys that are electronically provided to the student based at least in part on the captured student interaction data.

The systems and methods may electronically provide a personalized interactive educational display that provides controlled access to educational services, or commerce services, or any combination thereof. The personalized interactive educational display may electronically provide access to lecture notes, on-line discussion groups, educational resource materials, or course materials, or any combination thereof. One or more additional resource materials may be provided by the systems and methods based at least in part on demographics, the captured student interaction data, or academic performance, or any combination thereof. The systems and methods may further comprise determining which captured data elements have increased correlation with providing controlled access by applying factor analysis.

The disclosure also encompasses program products for providing personalized interactive educational displays based in part on the captured student interaction data of the type outlined above. In such a product, the programming is embodied in or carried on a machine-readable medium.

Additional features will be set forth in the description below, and in part will be apparent from the description, or may be learned by practice of the exemplary embodiments. The exemplary embodiments will be realized and attained by the structure particularly pointed out in the written description and claims hereof as well as the appended drawings.

It is to be understood that both the foregoing general description and the following detailed description are exemplary and explanatory and are intended to provide further explanation of the claims.

### BRIEF DESCRIPTION OF THE DRAWINGS

The accompanying drawings, which are included to provide further understanding of the exemplary embodiments and are incorporated in and constitute a part of this specification, illustrate embodiments and together with the description serve to explain the embodiments. In the drawings:

FIG. 1 illustrates an exemplary block-level diagram of an educational institutional environment in which a personalized interactive educational display system is implemented according to an exemplary embodiment;

FIG. 2 illustrates an exemplary flow diagram for providing a personalized interactive educational display to a student according to an exemplary embodiment;

FIG. 3 illustrates an exemplary personalized interactive display according to an exemplary embodiment;

FIG. 4 depicts an exemplary survey display for a student based on captured student interaction data according to an exemplary embodiment; and

FIG. 5 illustrates an exemplary display providing additional materials from a student-attended lecture according to an exemplary embodiment.

### DETAILED DESCRIPTION

In the following detailed description, numerous specific details are set forth to provide a full understanding of the exemplary embodiments. It will be obvious, however, to one ordinarily skilled in the art that the embodiments may be practiced without some of these specific details. In other instances, well-known structures and techniques have not been shown in detail so as not to obscure the embodiments.

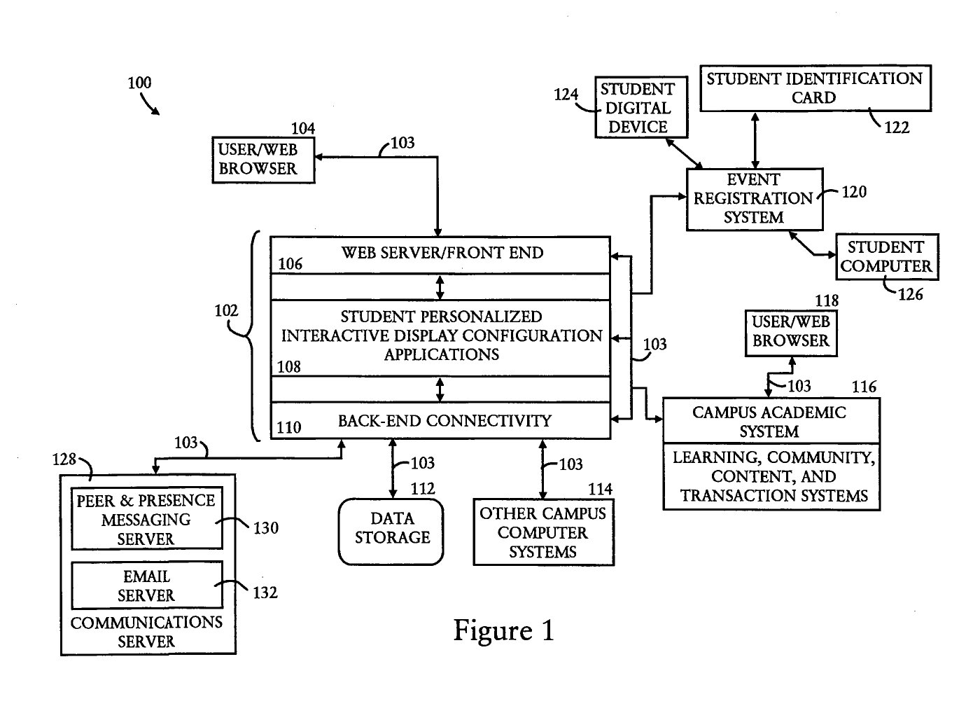

FIG. 1 depicts a functional block diagram of an exemplary personalized interactive educational display system 100. As described in more detail herein, system 100 may provide a framework for providing a student of an educational institution with a personalized interactive display which may provide access to resources (e.g., educational resources, communications resources, upcoming event information, purchasing information, etc.). Computing system 102 may be one or more computers (e.g., one or more servers, personal computers, minicomputers, mainframe computers, or any other suitable computing devices, or any combination thereof) that may be configured with front-end 106, student personalized interactive display configuration applications 108, and back-end connectivity 110.

User computer 104 may be configured to communicate with computer system 102 via a web browser or similar interface to communicate with an appropriately configured front-end 106 of system 102. Communication between user computer 104 and front end 106 of computer system 102 may be via communications link 103, which may be a wireless or wired communications link such as a local area network, wide area network, the Internet, or any other suitable communications network. Front-end 106 may be, for example, a web server or other computing device hosting one or more absence assessment applications 108 that user computer 104 may access.

Applications 108 may be one or more software components or programs that execute on a programmable computer platform of computer system 102 to provide functionality related to providing student personalized interactive display configuration applications. Such applications 108 may include components for capturing student interaction data (e.g., class attendance, use of campus facilities of the educational institution, student purchases of goods and/or services from merchants, etc.), providing personalized interactive displays, providing directed surveys based on the captured student interaction data, providing access to educational information, access to one or more student forums, access to student email, access to peer and presence messaging (e.g., instant messaging), providing recommendations for upcoming events, providing recommendations for purchases, or providing any other suitable information, or any combination thereof.

Computing system 102 may also access data storage facilities 112 and other computer systems 114 via communications link 103. For example, data storage facilities 112 may be one or more digital data storage devices configured with one or more databases having student data (e.g., student identification number, student name, student gender, student race, student expenditures, courses completed, course type (e.g., courses completed and/or selected, degree program, certificate programs, etc.), courses enrolled in, degree program, certificate program, etc.) and may also contain data received from a registration event with a student identification card, device configured with student information, and/or from registering an event by which a student entered identification data (e.g., a login event to a educational institution computer network application using student identification information). Data storage facilities 112 may store and arrange data in a convenient and appropriate manner for manipulation and retrieval. Other computer systems 114 may be a variety of third-party systems that contain data or resources that are useful for the data correlation system 100. In the exemplary higher education environment, systems 114 may include a student information system (SIS) that maintains student demographic information. Systems 114 may also include an electronically maintained class or course schedule for the institution that includes information about the courses such as section numbers, professors, class size, department, college, the students enrolled, etc. Other campus-related systems such as financial aid and the bursar's office may be included in systems 114 of FIG. 1.

Back-end connectivity 110 of computer system 102 may be appropriately configured software and hardware that interface between applications 108 and resources including, but not limited to, data storage 112 and other computer systems 114 via communications link 103.

Another resource to which the back end 110 may provide connectivity (e.g., via communications link 103) is a campus (or institutional) academic system 116. Campus academic system 116, in an academic environment, provides a platform that allows students and teachers to interact in a virtual environment based on the courses for which the student is enrolled. This system may be logically separated into different components such as a learning system, a content system, a community system, or a transaction system, or any other suitable system, or any combination thereof. For example, a student, administrator, faculty or staff member may operate user computer 118 to access academic system 116 via a web browser or similar interface.

Of particular usefulness to system 100, academic system 116 may provide a virtual space that user computer 118 may access to receive information and to provide information. One exemplary arrangement provides user computer 118 with a webpage where general information may be located and that has links to access course-specific pages where course-specific information is located. Electronic messaging, electronic drop boxes, and executable modules may be provided within the user's virtual space on the academic system 116. Thus, with respect to computer system 102, one of applications 108 may be used to generate information that is to be deployed to one or more users of academic system 116. Via back-end 110, the information may be sent to academic system 116 where it is made available to user computer 118 just as any other information may be made available. Similarly, from within the academic system 116, the user may enter and submit data that is routed through the back end 110 to one of the applications 108. Academic system 116 and computer system 102 may be more closely integrated so that the connectivity between the applications 108 and the system 116 is achieved without a network connection or back end software 110.

System 102 may be communicatively coupled to one or more registration systems 120, which may be a card reader, proximity reader, or other suitable system configured to capture information from student identification card 122, student digital device 124 (e.g., cellular phone, personal digital assistant, handheld computing device, laptop computer, etc.), or student computer 126. Although only one student identification card 122, student digital device 124, and computer 126 are shown, there may be one or more of each respective device that may communicate with registration system 120. Identification card 122, digital device 124, and/or computer 126 may be configured with student identification information (e.g., student name, student identification number, student spending account information, class schedule, major, dining services plan, dormitory, gender, race, nationality, etc.). For example, student identification card 122 may be swiped, scanned, or registered by proximity by registration system 120 at an event (e.g., purchasing event, cultural event, entertainment event, athletic event, etc.) to capture attendance by the student at the particular event or use of a facility. In another example, student identification card 122 may be swiped, scanned, or registered by proximity by registration system 120 at a particular vendor or retailer (e.g., on-campus merchant, off-campus merchant, dining service facility, concert hall, athletic stadium, etc.). Alternatively, student digital device 124 may communicate student identification information via a wired or wireless communications link with registration system 120 at an event. Also, student computer 126 may communicate with registration system 120 to provide student information and student spending account information with an on-line purchasing event (e.g., purchasing goods and/or services via an on-line retailer). Data captured by registration system 120 may be transmitted to computer system 102 via communications link 103 for processing (e.g., by applications 108, etc.) and/or storage (e.g., stored in data storage 112, etc.).

Data may be captured from student identification card 122 or student digital device 124 related to presence, utilizations, and transactions by a student. For example, a student may use card 122 or device 124 to purchase a ticket for a concert for the city symphony or a ticket for an exhibit at the city art museum. Card 122 or device 124 may be enabled with banking account, declining balance account, or credit card account information, or other financial transaction enabling information to facilitate the purchase of the tickets. Additionally, attendance of the symphonic concert or art museum exhibit by the student may be registered by registration system 120, which may be present at the city symphonic hall where the concert is being performed or at the art museum in order to receive student identification data and event information data (e.g., concert information, location of symphony hall, time of attendance, etc.) from the swiping or registering of student identification card 122 or device 124.

In another example, a student may use card 122 or device 124 to purchase a bus ticket or bus pass from the city's transportation authority. Again, card 122 or device 124 may also be enabled with banking account, declining balance account, or credit card account information, or other financial transaction enabling information to facilitate the purchase of the bus ticket (e.g., single ride, round-trip, etc.) or bus pass (e.g., 2 ride pass, 4 ride pass, weekly pass, weekend pass, monthly pass, academic year pass, year pass, etc.). Alternatively, a student may purchase a bus pass or ticket with card 122 or device 124, and information related to the pass or ticket may be associated with card 122 or device 124. Upon using the bus with card 122 or device 124 having associated bus pass or ticket information, the bus may be equipped with at least a portion of registration system 120 to register student use of the bus (e.g., identification information of the student, bus route information, time used, etc.) and may deduct from the bus use allowance of the purchased bus ticket or pass (e.g., deduct a day of use from the weekly pass purchased from the student's account, etc.).

In yet another example, a student may use card 122 or device 124 to purchase a pizza from an off-campus merchant, or purchase a Calculus study guide from the on-campus bookstore. During the purchasing transaction, card 122 may be swiped or read by a proximity reader (e.g., event registration system 120), and data may be captured such as the identity of the student, the location of the purchase (e.g., name and location of off-campus vendor), and data related to the items that were purchased (e.g., large pepperoni pizza; title, author, and publisher of the Calculus study guide purchased; cost of the items, etc.). Card 122 or device 124 may also be enabled with banking account, declining balance account, or credit card account information, or other financial transaction enabling information to facilitate the purchase of the items. In another example, student computer 126 may be used in an on-line purchasing transaction with an on-line merchant, wherein the student identification, identification information related to the items purchased, and information related to the on-line vendor may be captured by event registration system 120 (e.g., student computer 126 may transmit the information to event registration system 120 after the transaction).

Event registration system 120 may capture presence and utilization data by capturing data from student identification card 122, digital data device 124, and/or student computer 126 at particular events. For example, card 122 may be scanned (e.g., using event registration system 120) at the entrance of the educational institution's library (e.g., card 122 may be scanned at the entrance and exit of the library to record the times associated with entering and leaving), and may be scanned again when a student checks out a book. Thus, event registration system 120 may capture data related to the identity of the student, as well as the duration of time that the student was in the library, and information related to the book that the student checked out (e.g., author, title, genre, etc.). Similar registration of card 122 or device 124 by event registration system 120 may occur, for example, if the student attends a sporting event (e.g., a football game, etc.) or a cultural event such as a music concert (e.g., concert by string quartet, chamber orchestra, jazz band, etc.).

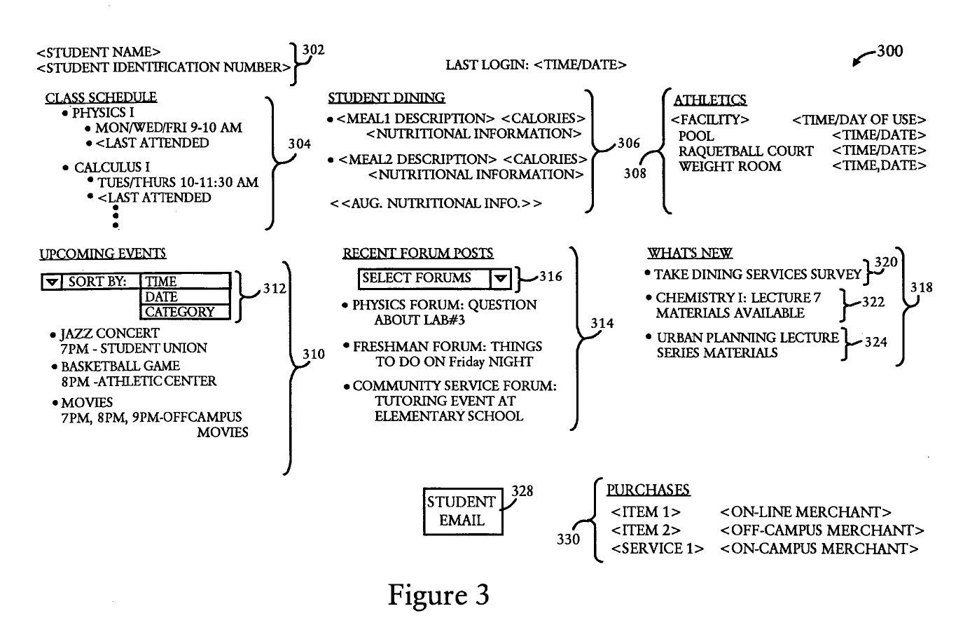

Computer system 102 may be communicatively coupled via communications link 103 to communications server 128, which may include peer and presence messaging server 130 and email server 132. Server 130 may enable peer and presence messaging (e.g., instant messaging) between one or more user computers (e.g., computers 104, computers 118, etc.). One or more user computers 104 and/or computers 118 may be configured with peer and presence messaging client applications, which may communicate with server 130, wherein server 130 provides messaging from one or more user computers 104 or 118 to one or more other user computers 104 or 118. Email server 132 may provide email messages received for a particular student to be directed to user computer 104 or 118, and may send email messages to other student or any other user computer communicatively coupled to system 100 by communications link 103. Alternatively, computer system 102 may include the peer and presence messaging server 130 and/or email server 132 (e.g., as a part of student personalized interactive display configuration applications 108, etc.). The personalized interactive educational display, such as exemplary display 300 described below and illustrated in FIG. 3, may enable a student to utilize peer and presence messaging or email to communicate with one or more other students.

Although front end 106, applications 108, and back end 110 of the computer system 102 are each depicted as a single block in FIG. 1, one of ordinary skill will appreciate that each may also be implemented using a number of discrete, interconnected components. As for the communication links between the various blocks of FIG. 1, a variety of functionally equivalent arrangements may be utilized. For example, some links may be via the Internet or other wide-area network, while other links may be via a local-area network or even a wireless interface. Also, although only a single computer 104 of computer system 102 is explicitly shown, multiple users and multiple computers or computing devices may be utilized in system 100. The structure of FIG. 1 is logical in nature and does not necessarily reflect the physical structure of such a system. For example, computer system 102 may be distributed across multiple computer platforms as can the data storage 1 12. The data storage 112 can be separate from or included as part of the computer system 102. Furthermore, components 106, 108, 110 are separate in the figure to simplify explanation of their respective operation. However, these functions may be performed by a number of different, individual components, or a more monolithically arranged component. Additionally, any of the three logical components 106, 108, 110 may directly communicate with the academic system 116 without an intermediary. Also, although the users 104, 118 are depicted as separate entities in FIG. 1, they may, in fact, be the same user or a single web browser instance concurrently accessing both computer system 102 and the academic system 116.

Correlating student interaction data with one or more displays of a personalized interactive educational display for a student is a complex undertaking that encompasses many different levels of data collection and analysis. System 100 may be used to capture student interaction data from one or more sources and provide one or more displays having course related information, dining information, athletic facilities use, on-line forum activity, recommended upcoming events, surveys, instant messaging, email, recommended items for purchase, or any other suitable information.

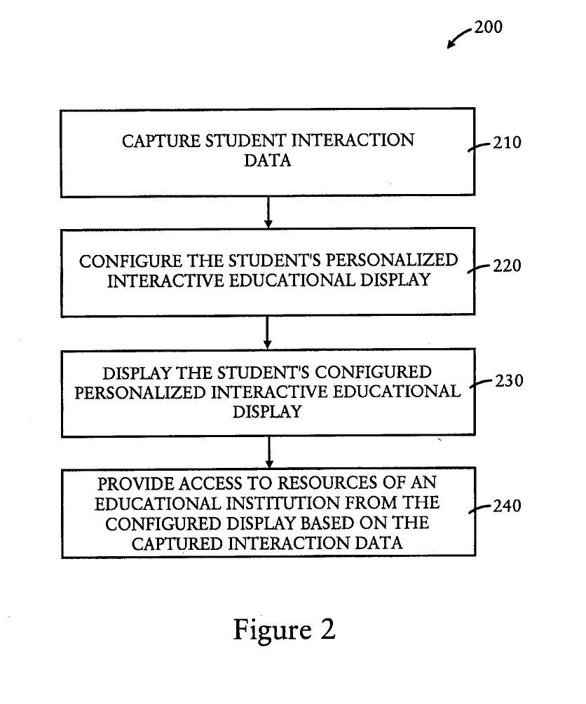

FIG. 2 depicts an exemplary diagram for flow 200 for providing a personalized interactive educational display to a student. Computer system 102 (FIG. 1) configured with applications 108 may, for example, perform flow 200. At block 210, at least some student interaction data may be captured, where the captured data has one or more elements.

For example, system 100 may capture data (e.g., using registration system 120) related to student interaction data. The captured student interaction data may relate to, for example, when and where a student has attended class, visited the library, utilized dining services, entered and exited a dormitory, utilized an athletic facility, utilized entertainment offerings on- or off-site from an educational campus, participated in educational online organizations, attended educational events or lectures outside of class, patronage of on-campus merchants, patronage of off-campus merchants, patronage of on-line merchants, electronic submission of an assignment or other document, or electronic submission of personal identification information, utilization of an on-campus resource, utilization of an off-campus resource, or any transactional or utilization information, or any combination thereof.

As computer system 102 is to provide a personalized interactive educational display (e.g., in display 300 of FIG. 3, etc.), captured data related to use of dining services, athletic facilities, attended events on- or off-campus, on-line forum participation, or other suitable activities may be used to provide current information to the personalized display. For example, the student may select a meal at the dining services facilities of the educational institution using a student meal plan associated with student identification card 122. Event registration system 120 may capture the identity of the student and information related to the selection of the meal, including the date and time of selection of the meal and/or entry into the dining services facility. Computer system 102 may indicate the captured information from the student's utilization of dining services in the personalized interactive educational display such that a student may track his or her consumption of food, and computer system may also provide a survey to a student via the personalized interactive educational display based on the student's recent meal selections with dining services.

In another example, registration system 120 may capture the identity of a student (e.g., from student identification card 122) who uses an athletic facility, as well as the time of use of the facility, which specific facility was used (e.g., swimming pool, ice rink, weight room, racquetball courts, etc.). Computer system 102 may present the student's recent visits to one or more athletic facilities as part of the personalized interactive educational display. Thus, a student may monitor his or her physical activity over a particular period of time by monitoring this section (e.g., display 308 illustrated in FIG. 3) of the interactive display.

At block 220, computer system 102 may configure the student's personalized interactive educational display. The configuration may be based, at least in part, on the captured data. For example, computer system 102 of system 100 may determine which captured information to present to the student, as well as additional information related to the captured data. Registration system 120 may capture information related to a student's meal selection at a dining services facility, and computer system 102 may present information related to the visit to dining services, as well as the selection of food items, and may also provide a survey notification to the student via the student's personalized interactive educational display.

In another example, computer system 102 may correlate at least some of the captured student interaction data by applying factor analysis, as described in further detail below, to determine which captured data elements have an increased correlation with event data. For example, based on the captured data of student attending particular cultural event (e.g., musical events, dance recitals, art exhibits, movies, etc.), social event, athletic event, community service event, or other events, computer system 102 may provide recommendations or highlight upcoming on-campus or off campus events based on the upcoming event's increased correlation with past attended events.

At block 230, computer system 102 may display the student's configured personalized interactive educational display. One exemplary display may be display 300 illustrated in FIG. 3 and described in further detail below.

At block 240, computer system 102 may provide access to resources of an educational institution from the configured display based on the captured interaction data. For example, the personalized interactive educational display may provide access to lecture materials related to a class that the student attended or related to a non-class lecture, access to on-line forums, or any other suitable access to resources of an educational institution. Exemplary access may be provided by display 300 illustrated in FIG. 3 and described below.

Factor analysis may be used by the exemplary systems described herein (e.g., system 100 of FIG. 1) as a statistical data reduction technique that may be used to explain variability among observed random variables in terms of fewer unobserved random variables (i.e., factors). The observed variables may be modeled as linear combinations of the factors. An advantage of factor analysis is the reduction of the number of variables by combining two or more variables into a single factor. Accordingly, factor analysis may be used for data reduction. For example, specific factors may be combined into a general, overarching factor such as academic performance. Another advantage of factor analysis is the identification of groups of inter-related variables to determine how they are related to each other. Thus, factor analysis may also be used as a structure detection technique. For example, poor performance on a Chemistry I quiz may be correlated a recommendation for the student to purchase a particular Chemistry study guide or have computer system 102 provide the student with additional Chemistry tutorials and questions which may measure improvement in academic performance in a particular subject area.

Correspondence analysis also may be performed by the exemplary systems as described herein. Correspondence analysis may be used, for example, to analyze two-way and multi-way tables containing one or more measures of correspondence between data (i.e., data in the rows and columns of the table). The results may provide information which is similar in nature to those produced by factor analysis techniques. The structure of categorical variables included in the table may be identified and summarized for presentation to a user (e.g., student, etc.).

In using factor analysis as a variable reduction technique, the correlation between two or more variables may be summarized by combining two variables into a single factor. For example, two variables may be plotted in a scatterplot. A regression line may be fitted (e.g., by computer system 102 of FIG. 1) that represents a summary of the linear relationships between the two variables. For example, if there are two variables, a two-dimensional plot may be performed, where the two variables define a plane. With three variables, a three-dimensional scatterplot may be determined, and a plane could be fitted through the data. With more than three variables it becomes difficult to illustrate the points in a scatterplot, but the analysis may be performed by computer system 102 to determine the regression summary of the relationships between the three or more variables. A variable may be defined that approximates the regression line in such a plot to capture the principal components of the two or more items. Data scores from student data on the new factor (i.e., represented by the regression line) may be used in future data analyses to represent that essence of the two or more items. Accordingly, two or more variables may be reduced to one factor, wherein the factor is a linear combination of the two or more variables.

The extraction of principal components may be found by determining a variance maximizing rotation of the original variable space. For example, in a scatterplot, the regression line may be the original X-axis, rotated so that it approximates the regression line. This type of rotation is called variance maximizing because the criterion for (i.e., goal of) the rotation is to maximize the variance (i.e., variability) of the “new” variable (factor), while minimizing the variance around the new variable. Although it is difficult to perform a scatterplot with three or more variables, the logic of rotating the axes so as to maximize the variance of the new factor remains the same.

After a line has been determined on which the variance is maximal, some variability remains around this first line. Upon extraction of the first factor (i.e., after the first line has been drawn through the data), another line may be defined that maximizes the remaining variability. In this manner, consecutive factors may be extracted. Because each consecutive factor is defined to maximize the variability that is not captured by the preceding factor, consecutive factors are independent of each other. Thus, consecutive factors are uncorrelated or orthogonal to each other.

In applying principal component analysis as a data reduction method (i.e., a method for reducing the number of variables), the number of factors desired to be extracted may be selected. As consecutive factors are extracted, the factors may account for decreasing variability. One method to determine when to stop extracting factors may depend on when the “random” variability has significantly decreased (i.e., very little random variability left). A correlation matrix may be used to determine the variance amongst each of the variables. The total variance in that matrix may be equal to the number of variables.

In contrast to the variable reduction methods of principal component analysis described above, principal factor analysis may also be performed by computer system 102 of FIG. 1 to determine the structure in the relationships between variables. The student interaction data may be used to form a “model” for principal factor analysis. For example, the student interaction data may be dependent on at least two components. First, there may be one or more underlying common factors. Each item may measure some part of this common aspect. Second, each item may also capture a unique aspect (of the common aspect) that may not be addressed by any other item.

If this model is correct, the factors may not extract substantially all variance from the items. Rather, only that proportion that is due to the common factors and shared by several items may be extracted. The proportion of variance of a particular item that is due to common factors (shared with other items) is called communality. The communalities for each variable may be estimated (i.e., the proportion of variance that each item has in common with other items). The proportion of variance that is unique to each item may then the respective item's total variance minus the communality. A common starting point is to use the squared multiple correlation of an item with all other items as an estimate of the communality. Alternatively, various iterative post-solution improvements may be made to the initial multiple regression communality estimate.

A characteristic that distinguishes between the two factor analytic models described above is that in principal components analysis (i.e., factor reduction) may assume that substantially all variability in an item should be used in the analysis, while principal factors analysis (i.e., structure detection) may use the variability in an item that it has in common with the other items. In most cases, these two methods usually yield very similar results. However, principal components analysis is often preferred as a method for data reduction, while principal factors analysis is often preferred when the goal of the analysis is to detect structure.

Computer system 102 of FIG. 1 configured with factor analysis applications programming (e.g., as part of applications 108) may provide personalized interactive educational displays to a student, correlate captured student interaction data with upcoming on-campus and off-campus events to provide recommendations or highlight particular events (e.g., lectures, cultural events, musical performances, art exhibits, etc.), provide recommendations for items to purchase based on captured purchase data, or apply factor analysis in any other suitable manner, or any combination thereof. System 102 may use quantitative techniques, such as data gathering from registration system 120 (e.g., swipes of student identification card 122, proximity readings of card 122, registration of digital device 124 configured with personal information), capturing transaction information (e.g., on-line purchases, class attendance, meals selected at dining services, etc.), to collect data related to a student's activities and academic performance. The captured data (taken alone or in combination with other data that may be stored, e.g., with data storage 112) may be used as input for a statistical application (e.g., applications 108) of computer system 102 of FIG. 1, which may process the data using factor analysis. System 102 may yield a set of underlying attributes (i.e., factors). Upon determination of the factors, system 102 may construct perceptual maps, graphs, or other textual or visual output to: recommended or highlighted upcoming events; provide recent on-line forum posts of interest to a student based on past usage of one or more forums; provide additional study and/or tutorial materials based at least in part on academic performance in one or more subjects; provide recommendations on future purchases based on previous purchases from on-campus, off-campus or on-line merchants, or any other suitable information. System 102 may present such maps, graphs, text, and/or numbers in displays for presentation in the personalized interactive educational display to a student.

Computer system 102 may be configured with programming that is executed to perform factor analysis on one or more elements of data to isolate underlying factors that summarize the resultant information as it relates to providing budget recommendations and identifying categories for a student to reduce expenditures. The factor analysis may be an interdependence technique, wherein one or more sets of interdependent relationships may be examined. The factor analysis may reduce the rating data on different attributes to a few important dimensions (e.g., academic performance in one or more subjects, events attended, on-line forums utilized, etc.). This reduction is possible because the attributes are related (e.g., the academic performance on a quiz may indicate that a student may need additional tutorial work to master the particular subject area, or the attendance of previous on-campus music events may be correlated with potential student interest in upcoming on-campus musical concerts, etc.). The rating given to any one attribute is partially the result of the influence of other attributes. Thus, system 102 may determine which events a student prefers to attend, which on-line forums a student frequently uses, goods and services a student uses a student spending account to purchase, or any other suitable information. The statistical programming (e.g., application 108) implemented on system 102 may deconstruct the rating (i.e., raw score) into one or more components, and reconstruct the partial scores into underlying factor scores. The amount of correlation between the initial raw score and the final factor score is referred to as factor loading.

FIG. 3 illustrates an exemplary personalized interactive educational display 300. Computer system 102 of FIG. 1 may present display 300 of FIG. 3 to a student or other person utilizing computer 104. In order for computer system 102 to present display 300 to computer 104 or 118, system 102 may prompt a user (e.g., student, etc.) to provide login information (e.g., usemame, password, etc.) to computer system 102 via computer 104 or 118. Upon computer system 102 authenticating the user-provided login information, system 102 may present display 300.

Student information 302 of display 300 may include a student name, student identification number, the date and time of the previous student login, or any other suitable information, or any combination thereof.

Display 300 may include a student class schedule 304, which may list each course that a student is presently enrolled in (e.g., Physics I, Calculus I, Introduction to Computer Science, American Literature, Spanish I, etc.), as well as the scheduled times and days that the course is provided by the educational institution. The information for class schedule 304 may be, for example, retrieved by computer system 102 from data storage 112, other campus computer systems 114, or campus academic system 116, or any combination thereof. For example, a student may be enrolled in Physics I, which may meet on Monday, Wednesdays, and Fridays from 9:00 AM to 10:00 AM. Class schedule 304 may also indicate the last class attended by the student for at least one of the courses. The class attendance information may be obtained from registration system 120 (e.g., student information regarding class attendance may be obtained from a proximity reader which reads student identification card 122 upon a student entering and exiting a classroom for a student's Physics I course), and provided to computer system 102. For example, the date and time of attendance for each course that a student is enrolled in may be provided in class schedule 304.

Display 300 may also include student dining display 306, which may indicate one or more meals selected or purchased by a student. The meals indicated in display 306 may be from an educational institution's dining services, or may be purchased from an on-campus or off-campus restaurant. For example, registration system 120 may read a student identification card having student meal plan information (e.g., 21 meals per week plan, 14 meals per week plan, declining balance account, etc.) and may associate the student identification number or other identifying information related to the student with a meal purchased at a dining services facility. The location of the dining facility.(e.g., particular dining services facility on the campus of an educational institution or location of an off-campus restaurant, etc.) and the time and date of the visit (e.g., the time and date that a student visited the dining services facility or off-campus restaurant, etc.) may also be provided in student dining display 306. Dining related information may be provided, for example, for the present day, the last two days, the last week, or any other suitable time period. Student dining display 306 may also include nutritional information related to the purchased meals. Nutritional information may include amount of calories, fat, proteins, carbohydrates, sugars, vitamins, or any other suitable information, or any combination thereof for one or more meals. Display 306 may also provide an average nutritional summary for a particular predefined number of meals (e.g., the number of calories for each breakfast meal eaten over the last week, etc.). A student may use student dining display 306 of display 300 to monitor his or her nutrition and eating habits (e.g., frequency of meals, number of calories per meal, etc.). The nutritional information may be provided directly to a diet program, which would allow a dieter to avoid having to input the nutritional information into the diet program, or the points, meal equivalents, etc. The diet program can then automatically provide the user with information on how many points are left for their next meal, or other information, for example.

Display 300 may also include athletics display 308, which may indicate athletic facilities that a student has used within a particular period of time (e.g., on the current day, within the last two days, within the last week, within the last month, etc.). Athletic facilities usage information may be obtained from registration system 120. For example, display 308 may indicate that a student utilized the swimming pool, racquetball courts, and weight room. Display 308 may indicate, for example, the frequency of use for a particular time period (e.g., a student used the racquetball courts on Tuesday and Thursday for an hour on each day, from 7 PM-8 PM). Display 308 may also indicate the average number of uses of athletic facilities and the average time period used for a particular period of time (e.g., the student used the weight room three times for the last week for an average of 47 minutes). A student may use athletics display 308 of display 300 in order to monitor their fitness (i.e., determine whether they are exercising regularly) while attending the educational institution.

Upcoming events display 310 of display 300 may indicate on-campus and/or off-campus educational, cultural, entertainment, or any other suitable events. Events may be pre-selected and displayed based on previous attendance of events (e.g., for a student who previously attended three basketball games where attendance information was captured by registration system 120, computer system 102 may list or highlight that a basketball game in being played at the educational institution's athletic center at 8 PM on a particular date). Computer system 102 may utilize factor analysis of applications 108 as described above to determine the correlation between previously attended events and upcoming events to provide a recommended list of events or highlighted events for a student. Alternatively, computer system 102 may present one or more upcoming events in display 310 without recommending or highlighting specific events. Display 310 may also be sorted by selecting options in drop-down menu 213 for time, date, category (e.g., athletic events, educational lectures, music events, art events, movies, etc.), or any other suitable sort option, or any combination thereof.

Recent forum posts display 314 of display 300 may indicate one or more posts made to one or more forums. The one or more posts may have been made to the forums within, for example, the previous 10 minutes, the previous hour, the last day, or week, or any other suitable time period. Display 314 may indicate posts to forums of which a student is a member or has participated in. Alternatively, if the student is not presently a member of any on-line forum or has not yet participated in any forums, computer system 102 may select recent posts from forums to display, such as from the most popular thread, or may select recent posts from forums based at least in part on a student's class schedule (i.e., courses presently enrolled in), a student's major, previously attended events (e.g., cultural events, athletic events, lectures, etc.), or using any other suitable criteria. For example, a student may be a member of the Physics Forum, the Freshman Forum, and the Community Service Forum. In this example, display 314 may indicate a recent post on the Community Service Forum regarding an upcoming tutoring event at a local elementary school. A student may select the post from display 314, and computer system 102 may provide a display with the selected post, and may also display related posts. A student may also access one or more forums by selecting a forum from drop down menu 316. Upon selection of a forum from drop-down menu, a display related to the selected forum may be presented to the user using computer 104 by computer system 102.

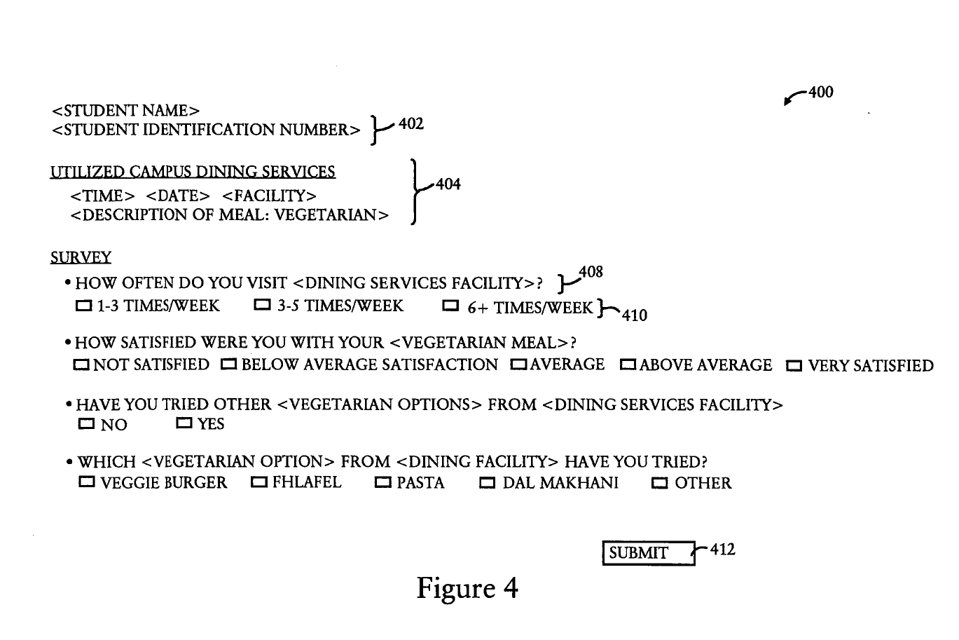

New items display 318 (i.e., “what's new”) may highlight particular new items for the student user occurring from their last login to display 300. For example, the student may have used the educational institution's dining services (e.g., as determined by registration system 120) and a survey request may have been sent to the student's personalized interactive educational display 300 based on a meal that a student selected at dining services. The student may have selected a new vegetarian meal offered by dining services, and the educational institution may desire feedback on various aspects of the meal (e.g., a score for the taste of the entree purchased by the student as determined by the captured data, a score for the presentation of that entree, etc.). In this example, survey request 320 may appear in new items display 318. Upon selection of survey request 320 by the student, computer system 102 may present a dining services survey display 400 of FIG. 4 for the student to complete electronically using computer 104.

Dining services survey display 400 may indicate student information 402, which may include, for example, the student's name, student identification number, or any other suitable information. Utilized campus dining services information 404 may indicate the time (e.g., time of entry into the dining services facility, or time or purchase of the meal, etc.), date, facility (e.g., a particular dining services facility located on the educational institution's campus), or the one or more meals selected, or any other suitable information, or any combination thereof. For example, dining services survey display 400 may relate to a new vegetarian meal that an educational institution's dining services has introduced and is soliciting feedback in connection with the service of this meal. Survey questions 406 may include one or more questions 408 and answer selection elements 410 for a student to select. Upon completion of the survey, a student may select “submit” button 412, which provides the survey answers provided by the student to computer system 102 for storage and processing. Upon capturing and processing one or more surveys, computer system 102 may compile summary survey results for an administrator or other user to view via computer 104 or 118.

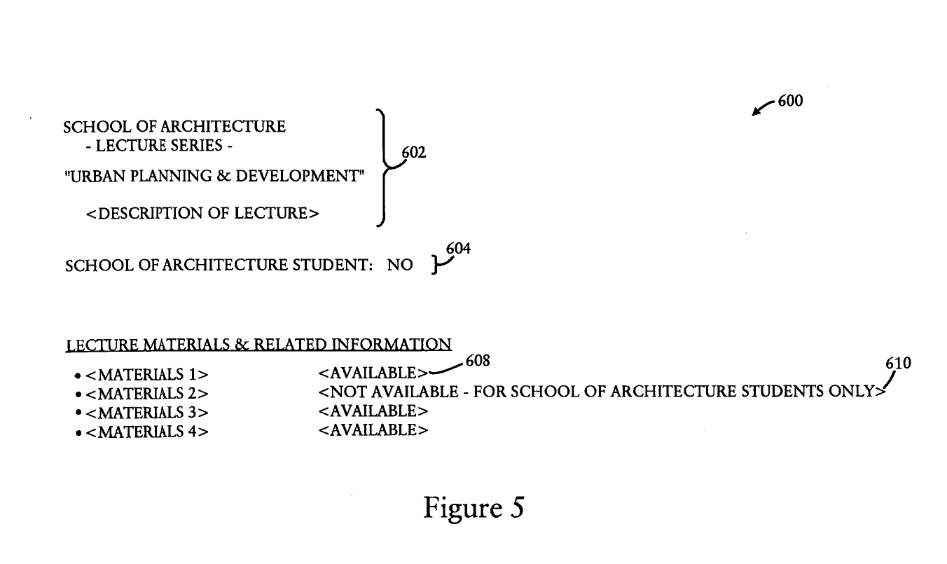

Turning again to FIG. 3, new items display 318 may indicate, for example, that urban planning and development materials 324 are available to the student, based on the student's attendance to an urban planning lecture (e.g., which may have been sponsored by the educational institution's school of architecture). Upon selection of urban planning and development materials 324 from new items display 318, computer system 102 may present lecture materials display 600 of FIG. 5.

Display 600 may indicate title and descriptive information 602 of the lecture attended, which may include a brief description of the subject of the lecture. Display 600 may also indicate whether the student is associated with the educational institution's school of architecture (e.g., with student status 604). Computer system 102 may utilize student data from data storage 112, other campus computer system 114, or any other suitable data storage system that may be part of system 100. For example, if the student is not associated with the educational institution's school of architecture, computer system 102 may provide limited or preselected supplemental lecture materials (e.g., available materials 608 of materials list 606) to the student via display 600. However, if computer system 102 determines that the student is associated with the school of architecture, additional materials (e.g., materials 610) related to the urban planning and development may be present in display 600. In the example illustrated in FIG. 5, the student is not associated with the school of architecture, and materials 610 are thus indicated as being unavailable to the student, while materials 608 are indicated as being available to the student (and are available to others who attended the lecture, based on the data received by computer system 102 from registration system 120). Although in the example described above, association with the school of architecture or attendance of the lecture are used to determine access to particular materials, other suitable criteria may be used (e.g., a person may access one or more materials via display 600 if the person is a student, faculty, staff, alumni, or other person with an identification card or number with the educational institution).

Display 300 may also include purchases display 330, which may indicate purchases made by a student within a predefined period of time (e.g., within the last 6 hours, day, 2 days, 1 week, etc.). Information for purchases display 330 may be obtained from purchasing transactions captured by registration system 120. Display 330 may indicate the good or services purchases, as well as the identity of the merchant. Display 300 may also indicate whether the merchant is an on-campus, off-campus, or on-line merchant.

Displays 302, 304, 306, 308, 310, 314, 318, 326, and 330, as well as “student email” button 328 may be arranged in display 300 by applications 108 of computer system 102 or by a user selecting and arranging displays 302, 304, 306, 308, 310, 314, 318, 326, and 330 as well as “student email” button 328 using computer 104 or 118, or any combination thereof.

The detailed description set forth above in connection with the appended drawings is intended as a description of various embodiments and is not intended to represent the only embodiments which may be practiced. The detailed description includes specific details for the purpose of providing a thorough understanding of the embodiments. However, it will be apparent to those skilled in the art that the embodiments may be practiced without these specific details. In some instances, well known structures and components are shown in block diagram form in order to avoid obscuring the concepts of the exemplary embodiments.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but is to be accorded the full scope consistent with the language claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for electronically providing a personalized interactive educational display to a student, comprising:
capturing student interaction data, wherein the student interaction data has one or more data elements;
configuring the student's personalized interactive educational display based at least in part on the captured student interaction data;
displaying the student's configured personalized interactive educational display; and
providing access to resources of an educational institution from the student's configured personalized interactive educational display based at least in part on the captured student interaction data.

2. The method of claim 1, wherein the capturing the student interaction data comprises swiping a card configured with student data, reading a card configured with student data with a proximity reader, retrieving student data stored on an electronic device via a wired or wireless communication interchange, recording a computer login event using student identifier data, or digitally capturing student identification information from an electronically submitted communication, or any combination thereof.

3. The method of claim 2, wherein the capturing of the student interaction data indicates student class attendance, student activity attendance, student educational event attendance, student cultural event attendance, student athletic event attendance, student participation in one or more on-line communities, student entertainment attendance, student patronage of on-campus merchants, student patronage of off-campus merchants, student patronage of on-line merchants, student utilization of an on-campus resource, student utilization of an off-campus resource, student electronic submission of an assignment, student electronic submission of student identification information, athletic facilities utilization, laboratory facilities utilization, dining facilities utilization, research facilities utilization, recreational facilities utilization, classroom facilities utilization, computing facilities utilization, performance space facilities utilization, clinical facilities utilization, art studio facilities utilization, dormitory facilities utilization, parking facilities utilization, retail facilities utilization, entertainment facilities utilization, or library facilities utilization or any combination thereof.

4. The method of claim 1, wherein directed surveys are electronically provided to the student based at least in part on the captured student interaction data.

5. The method of claim 1, wherein the personalized interactive educational display provides controlled access of educational services, or commerce services, or any combination thereof.

6. The method of claim 5, wherein the personalized interactive educational display electronically provide access to lecture notes, on-line discussion groups, educational resource materials, or course materials, or any combination thereof.

7. The method of claim 5, wherein one or more additional resource materials are provided based at least in part on the captured student interaction data, or academic performance, or any combination thereof.

8. The method of claim 5, further comprising determining which captured data elements have increased correlation with providing controlled access by applying factor analysis.

9. A system for electronically providing a personalized interactive educational display to a student, comprising:
a programmable computer configured to:
capture student interaction data, wherein the student interaction data has one or more data elements;
configure the student's personalized interactive educational display based at least in part on the captured student interaction data;
display the student's configured personalized interactive educational display; and
provide access to resources of an educational institution from the student's configured personalized interactive educational display based at least in part on the captured student interaction data.

10. The system of claim 9, wherein the programmable computer configured to capture the student interaction data is further configured to receive card swipe data from a card configured with student data at an event, read a card configured with student data with a proximity reader, retrieve student data stored on an electronic device via a wired or wireless communication interchange, record a computer login event using student identifier data, or digitally capture student identification information from an electronically submitted communication, or any combination thereof.

11. The system of claim 10, wherein the programmable computer configured to capture the student interaction data is further configured to determine student class attendance, student activity attendance, student educational event attendance, student cultural event attendance, student athletic event attendance, student participation in one or more on-line communities, student entertainment attendance, student patronage of on-campus merchants, student patronage of off-campus merchants, student patronage of on-line merchants, student utilization of an on-campus resource, student utilization of an off-campus resource, student electronic submission of an assignment, student electronic submission of student identification information, athletic facilities utilization, laboratory facilities utilization, dining facilities utilization, research facilities utilization, recreational facilities utilization, classroom facilities utilization, computing facilities utilization, performance space facilities utilization, clinical facilities utilization, art studio facilities utilization, dormitory facilities utilization, parking facilities utilization, retail facilities utilization, entertainment facilities utilization, or library facilities utilization or any combination thereof.

12. The system of claim 9, wherein the programmable computer is further configured to electronically provide surveys to the student based at least in part on the captured student interaction data.

13. The system of claim 9, wherein the personalized interactive educational display provides controlled access of educational services, or commerce services, or any combination thereof.

14. The system of claim 13, wherein the personalized interactive educational display electronically provide access to lecture notes, on-line discussion groups, educational resource materials, or course materials, or any combination thereof.

15. The system of claim 13, wherein one or more additional resource materials are provided based at least in part on the captured student interaction data, or academic performance, or any combination thereof.

16. The system of claim 13, wherein the programmable computer is further configured to determine which captured data elements have increased correlation with providing controlled access by applying factor analysis.

17. Computer readable media containing programming instructions for providing a personalized interactive educational display to a student, that upon execution thereof, causes one or more processors to perform the steps of:
capturing student interaction data, wherein the student interaction data has one or more data elements;
configuring the student's personalized interactive educational display based at least in part on the captured student interaction data;
displaying the student's configured personalized interactive educational display; and
providing access to resources of an educational institution from the student's configured personalized interactive educational display based at least in part on the captured student interaction data.

18. The computer readable media of claim 17, wherein the capturing the student interaction data comprises swiping a card configured with student data, reading a card configured with student data with a proximity reader, retrieving student data stored on an electronic device via a wired or wireless communication interchange, recording a computer login event using student identifier data, or digitally capturing student identification information from an electronically submitted communication, or any combination thereof.

19. The computer readable media of claim 18, wherein the capturing of the student interaction data indicates student class attendance, student activity attendance, student educational event attendance, student cultural event attendance, student athletic event attendance, student participation in one or more on-line communities, student entertainment attendance, student patronage of on-campus merchants, student patronage of off-campus merchants, student patronage of on-line merchants, student utilization of an on-campus resource, student utilization of an off-campus resource, student electronic submission of an assignment, student electronic submission of student identification information, athletic facilities utilization, laboratory facilities utilization, dining facilities utilization, research facilities utilization, recreational facilities utilization, classroom facilities utilization, computing facilities utilization, performance space facilities utilization, clinical facilities utilization, art studio facilities utilization, dormitory facilities utilization, parking facilities utilization, retail facilities utilization, entertainment facilities utilization, or library facilities utilization or any combination thereof.

20. The computer readable media of claim 17, wherein directed surveys are electronically provided to the student based at least in part on the captured student interaction data.

21. The computer readable media of claim 17, wherein the personalized interactive educational display provides controlled access of educational services, or commerce services, or any combination thereof.

22. The computer readable media of claim 21, wherein the personalized interactive educational display electronically provide access to lecture notes, on-line discussion groups, educational resource materials, or course materials, or any combination thereof.

23. The computer readable media of claim 21, wherein one or more additional resource materials are provided based at least in part on the captured student interaction data, or academic performance, or any combination thereof.

24. The computer readable media of claim 21, further comprising determining which captured data elements have increased correlation with providing controlled access by applying factor analysis.
